(19) United States
(12) Patent Application Publication
(10) Pub. No.: US 2013/0038145 A1
(43) Pub. Date: Feb. 14, 2013

(54) DRIVE DEVICE, AND MOVEMENT MECHANISM USING DRIVE DEVICE

(71) Applicants: Shigeki Fujiwara, Osaka (JP); Youhei Ishigami, Osaka (JP); Yoshio Mitsutake, Osaka (JP); Satoshi Suzuki, Osaka (JP)

(72) Inventors: Shigeki Fujiwara, Osaka (JP); Youhei Ishigami, Osaka (JP); Yoshio Mitsutake, Osaka (JP); Satoshi Suzuki, Osaka (JP)

(73) Assignee: SANYO ELECTRIC CO., LTD., Osaka (JP)

(21) Appl. No.: 13/577,545

(22) PCT Filed: Feb. 16, 2011
(86) PCT No.: PCT/JP2011/053237

§ 371 Date: Oct. 11, 2012

(30) Foreign Application Priority Data
Feb. 16, 2010 (JP) 2010-031840

(51) Int. Cl. H02K 33/16; H02K 33/18

(52) U.S. Cl. 310/20

(57) ABSTRACT

A drive device which provides an electromagnetic impact and a movement mechanism using the drive device to achieve a reciprocating movement with a compact and simple configuration. A drive device provides an impact to an object-to-be-moved supported by a friction surface and moves the object-to-be-moved, and includes an electromagnetic coil, a permanent magnet, a stopper, and a control device which controls the electromagnetic coil. The permanent magnet relatively moves to the electromagnetic coil by an action caused by an electrical current supply to the electromagnetic coil. When the electrical current is supplied to the electromagnetic coil, the permanent magnet collides with the electromagnetic coil or the stopper, which forms the collided-body, and generates the impact. The impact can be generated in any direction, then a reciprocating movement of the object-to-be-moved can be achieved.

### TECHNICAL FIELD

The present invention relates to a drive device using an electromagnetic action and a movement mechanism using the drive device.

### BACKGROUND ART

Conventionally, there is a drive device which repeatedly provides a shock, that is to say, an impact, caused by an electromagnetic action to an object and moves the object. Even the small impact enables the movement of the object when being provided repeatedly, and moreover, it also has an advantage that it enables a high-accuracy position control. There is a known method of using an electrostrictive element or an eddy current to generate the impact (refer to patent documents 1 and 2, for example). The eddy current is a current which circularly flows in a metal plate such as an aluminum plate, for example, when a current flows in an electromagnetic coil which is located close to the metal plate. When an impulse current flows in the electromagnetic coil, a repulsion force which bounces the metal plate off occurs by an interaction between a magnetic field from the electromagnetic coil and the eddy current induced on the metal plate. When the bounced metal plate collides with the object, the impact can be provided to the object via the metal plate. There is a known apparatus which applies such a drive device to a micromanipulator and inserts a fine implement into an ovule using the micromanipulator (refer to patent document 3, for example).

### PRIOR ART DOCUMENT(S)

### Patent Document(S)

Patent Document 1: Japanese Laid-Open Patent Publication No. 60-60582

Patent Document 2: Japanese Patent Publication No. 5-80685

Patent Document 3: Japanese Laid-Open Patent Publication No. 2003-25261

### DISCLOSURE OF THE INVENTION

However, the drive device described in the above patent documents 1 to 3 can only generate the impact in one side (aspect or sense) of a direction using one drive device, and therefore two drive devices are required to reciprocate the object. Thus, a movement mechanism in which an object is reciprocated by such a drive device has problems that a downsizing of the device is restricted and an increased number of the drive devices causes troublesome tasks for parts management and assembly.

The present invention is to solve the above problems, and an object of the present invention is to provide a drive device which can achieve a reciprocating movement and a movement mechanism using the drive device with a compact, simple, and inexpensive configuration.

According to an aspect of the present invention, this object is achieved by a drive device for providing an impact to an object-to-be-moved and moving the object-to-be-moved, the drive device comprises: an electromagnetic coil; a permanent magnet which relatively moves relative to the electromagnetic coil by an electromagnetic action caused by an electrical current-supply to the electromagnetic coil; and a stopper for restricting a range of the relative movement of the electromagnetic coil or the permanent magnet, wherein the stopper forms a collided-body by being integrated with either the electromagnetic coil or the permanent magnet, and when an electrical current is supplied to the electromagnetic coil, the collided-body collides with either the electromagnetic coil or the permanent magnet which is not integrated in the collided-body, and generates the impact to the object-to-be-moved.

In the drive device, the stopper may have a non-magnetic material and form the collided-body by being integrated with the non-magnetic material and the electromagnetic coil, the permanent magnet may be placed between the stopper and the electromagnetic coil and can relatively move therebetween relative to the electromagnetic coil, and the permanent magnet may collide with the electromagnetic coil by an attraction force caused by the electromagnetic action or may collide with the stopper by a repulsion force caused by the electromagnetic action, and generates the impact.

In the drive device, the stopper may have another permanent magnet which differs from the permanent magnet, and forms the collided body by being integrated with those two permanent magnets, the electromagnetic coil may be placed between the two permanent magnets and can relatively move therebetween relative to the respective permanent magnets, and the electromagnetic coil may collide with one of the two permanent magnets by an attraction force and a repulsion force received from the two permanent magnets by the electromagnetic action, and generates the impact.

In the drive device, the electromagnetic coil and the permanent magnet may be combined with each other to make a voice coil structure, the stopper may have a non-magnetic material and form the collided-body by being integrated with the non-magnetic material and the permanent magnet on both ends of the permanent magnet in a direction of the relative movement, the electromagnetic coil can relatively move between the stopper relative to the permanent magnet, and the electromagnetic coil may collide with the stopper by a force which is caused by the electromagnetic action received from the permanent magnet, and generates the impact.

Moreover, the drive device may comprise a control device which temporally controls an electrical current flowing to the electromagnetic coil, the control device supplies a current to generate the collision in one direction of the relative movement, and supplies a current reversely to prevent the collision in an opposite of one direction so that the impact is repeatedly generated in one direction.

A movement mechanism according to the present invention comprises: a first moving table; a second moving table which is supported by the first moving table and relatively moves relative to the first moving table; and drive means which drive and move the first and second moving tables, respectively, wherein any of the above drive devices is used as the drive means.

A movement mechanism according to the present invention comprises: a moving table which moves on a flat surface; and drive means which drives and moves the moving table, wherein any of the above drive devices is used as the drive means.

A movement mechanism according to the present invention comprises: a gimbal structure; and a rotary drive means which rotationally moves a rotatable structure around rotational axis in the gimbal structure, wherein any of the above drive devices is used as the rotary drive means.

According to the drive device of the present invention, since the impact caused by the collision can be generated in any side of the direction of the relative movement of the electromagnetic coil and the permanent magnet, a reciprocating movement of the object-to-be-moved can be achieved. Moreover, since the drive device is made by combining the permanent magnet and the stopper with one electromagnetic coil, a compact and simple configuration can be achieved. By using this drive device, a movement mechanism such as a moving table, an inclination stage, or the like, for example, can be achieved by a compact, lightweight and simple configuration compared to a case of using a motor, a driving force transmission device, or the like.

Moreover, according to the movement mechanism of the present invention, an XY table, a rectilinear movable table, a XYθ table, a gimbal structure which controls an inclination angle, a rotation angle, or the like of a moving object, or the like can be achieved with a compact, simple, and inexpensive configuration without using a motor, a driving force transmission device such as a ball screw, or the like.

### BRIEF DESCRIPTION OF THE DRAWINGS

FIG. 1 is partial cross-sectional side view of a drive device according to a first embodiment of the present invention.

FIG. 2A is a schematic diagram for illustrating a principle of operation with a repulsion force in the drive device, and FIG. 2B is a schematic diagram for illustrating a principle of operation with an attraction force in the drive device.

FIG. 3 is a graph showing a change of a current flowing in an electromagnetic coil with time when the drive device is operated.

FIG. 4A to 4D are partial cross-sectional side views showing the drive device operating in accordance with the current change in FIG. 3.

FIG. 5 is another graph showing a change of a current flowing in the electromagnetic coil with time when the drive device is operated.

FIG. 6A to 6F are partial cross-sectional side views showing the drive device operating in accordance with the current change in FIG. 5.

FIG. 7 is a partial cross-sectional side view of a modification example of the drive device.

FIGS. 8A and 8B are pattern diagrams for illustrating a principle of operation in the modification example.

FIGS. 9A to 9C are partial cross-sectional side views showing an example of the operation of the modification example in left direction in chronological order.

FIGS. 10A to 10C are partial cross-sectional side views showing an example of the operation of the modification example in right direction in chronological order.

FIG. 11 is a partial cross-sectional side view showing a modification example of the modification example.

FIGS. 12A and 12B are schematic diagrams for illustrating a principle of operation of the modification example of FIG. 11.

FIG. 13A is a partial cross-sectional plane view showing another modification example of the drive device, FIG. 13B is a cross-sectional view of FIG. 13A along a line A-A, and FIG. 13C is a cross-sectional view of FIG. 13B along a line B-B.

FIG. 14 is a plane sectional view for illustrating a principle of operation of the modification example.

FIGS. 15A to 15C are partial cross-sectional side views showing an example of the operation of the modification example.

FIGS. 16A and 16B are graphs showing a change of a current flowing in an electromagnetic coil with time when the modification example is operated.

FIG. 17A to 17C are perspective views showing an example of an operation of a movement mechanism according to a second embodiment.

FIGS. 18A is a perspective view showing a modification example of the movement mechanism and FIG. 18B is a perspective view showing another modification example of the movement mechanism.

FIG. 19 is a perspective view showing still another modification example of the movement mechanism.

FIGS. 20A and 20B are perspective views showing a movement mechanism and an example of an operation according to a third embodiment.

FIG. 21A is a side view showing an example of a rotation movement of the movement mechanism rotating around a Y axis, and FIG. 21B is a side view showing the rotation movement of the movement mechanism viewed from another perpendicular side.

FIG. 22A is a side view showing an example of a rotation movement of the movement mechanism rotating around an X axis, and

FIG. 22B is a side view showing the rotation movement of the movement mechanism viewed from another perpendicular side.

FIG. 23 is a partial cross-sectional side view showing still another modification example of the drive device according to the first embodiment.

FIG. 24 is a cross-sectional side view showing still another modification example of the drive device according to the first embodiment.

FIGS. 25A and 25B are partial enlarged sectional views showing the modification example.

FIGS. 26A to 26D are partial cross-sectional side views showing an operation of the modification example.

### DESCRIPTION OF THE EMBODIMENT(S)

### First Embodiment

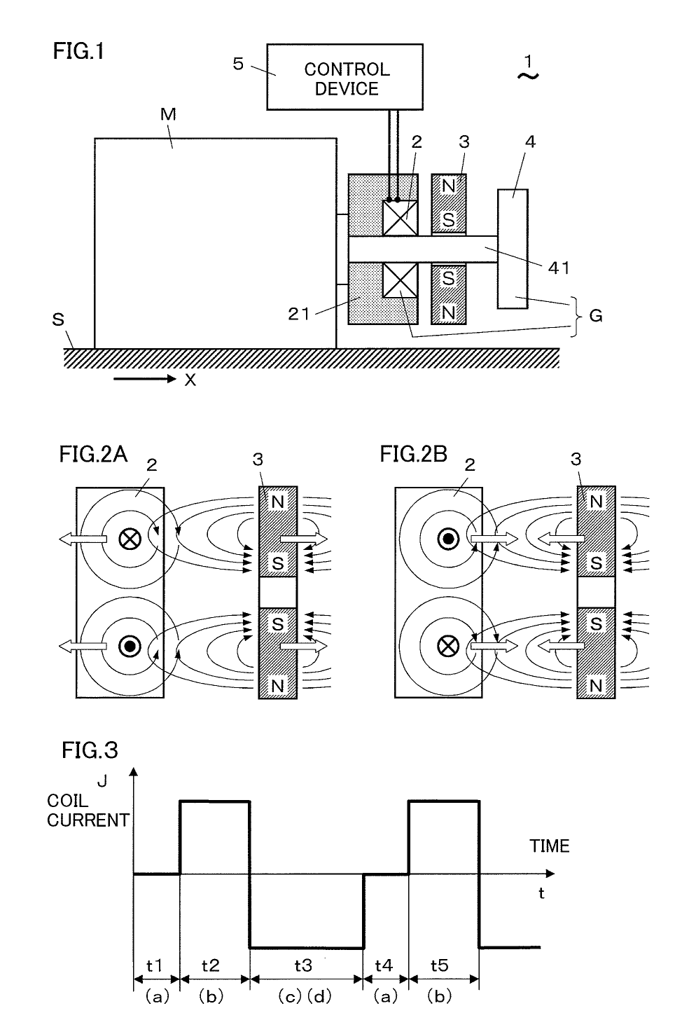

A drive device and a movement mechanism using the drive device according to embodiments of the present invention are described with reference to the drawings. FIGS. 1 to 6F show a drive device according to the first embodiment. As shown in FIG. 1, a drive device 1, which provides an impact to an object-to-be-moved M and moves the object-to-be-moved M, includes an electromagnetic coil 2, a permanent magnet 3, a stopper 4, and a control device 5. The permanent magnet 3 relatively moves relative to the electromagnetic coil 2 by an electromagnetic action caused by an electrical current-supply to the electromagnetic coil 2. The stopper 4 is integrated with the electromagnetic coil 2 to form a collided-body G so that a range of the relative movement of the permanent magnet 3 is restricted. The control device 5 temporally controls an electrical current supplied to the electromagnetic coil 2. When the electrical current is supplied to the electromagnetic coil 2 in the drive device 1, the permanent magnet 3 collides with the collided-body G (that is to say, the electromagnetic coil 2 or the stopper 4), and this collision generates the impact. A term of this collided-body G is only used as a name indicating a partner object with which the permanent magnet 3 collides (a partner object of relative movement) and thus does not have other meaning (the same shall apply hereinafter). The electromagnetic coil 2 is placed in a coil frame 21 and is integrated with the stopper 4 by an axial rod 41 which is located on a central axis of the electromagnetic coil 2 and the coil frame 21. The permanent magnet 3 has a shape of a toroidal circular plate and is magnetized from a center side toward an outer periphery side in a radial direction. In the present embodiment, S pole is located on the center side and N pole is located on the outer periphery side, however, the polarity may be reversed. The above permanent magnet 3 is subject to a repulsion force as shown in FIG. 2A and is subject to an attraction force as shown in FIG. 2B depending on a direction of the electrical current flowing in the electromagnetic coil 2.

An operation of the drive device 1 is described. As shown in FIG. 1, the drive device 1 provides an impact to an object-to-be-moved M which is located on a friction surface S and moves the object-to-be-moved M along the direction of the axial rod 41 (along X axis direction, a left-right direction in the drawings). The electromagnetic coil 2, to which electrical current is supplied, is a generation-source of the impact. The object-to-be-moved M is moved to the left in accordance with a collision of the permanent magnet 3 with the electromagnetic coil 2 located on the left side and moved to the right in accordance with a collision of the permanent magnet 3 with the stopper 4 located on the right side. Accordingly, when the object-to-be-moved M is moved to the left, a magnetic force from the electromagnetic coil 2 needs to act on the permanent magnet 3 so that the permanent magnet 3 does not collide with the stopper 4. In contrast, when the object-to-be-moved M is moved to the right, the magnetic force from the electromagnetic coil 2 needs to act on the permanent magnet 3 so that the permanent magnet 3 does not collide with electromagnetic coil 2. The control device 5 repeatedly generates the impact in one side of the direction by temporally controlling the electrical current flowing in the electromagnetic coil 2. That is to say, by controlling the electrical current, the control device 5 generates the collision in one side of the direction of the relative movement of the electromagnetic coil 2 and the permanent magnet 3, and prevents the collision in the opposite side of the direction, and reverses the relative movement, so that the control device 5 repeatedly generates the impact in one side of the direction.

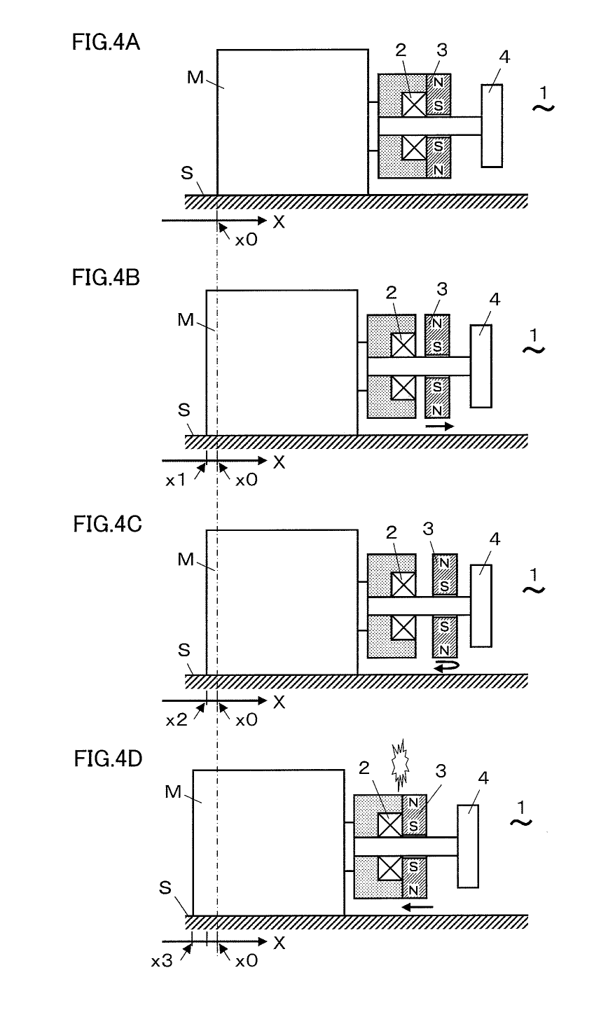

The control device 5, by temporally controlling a coil current J as shown in FIG. 3, moves the object-to-be-moved M to the left as shown in FIGS. 4A to 4D. Symbols (a) to (d) in the graph of FIG. 3 approximately correspond to FIGS. 4A to 4D, respectively. The coil current J is zero in a time t1 in FIG. 3, and the object-to-be-moved M remains stationary as shown in FIG. 4A. When the predetermined coil current J flows as in a time t2, the permanent magnet 3 is subject to a repulsion force from the electromagnetic coil 2 and gets close to the stopper 4 as shown in FIG. 4B. Before the permanent magnet 3 reaches the stopper 4, the coil current J, whose polarity is reversed, flows in a time t3, and the permanent magnet 3 is subject to an attraction force from the electromagnetic coil 2 and gets close to the electromagnetic coil 2 as shown in FIGS. 4C and 4D. When the permanent magnet 3 moves to the electromagnetic coil 2, its movement speed is continuously accelerated by the attraction force, and the permanent magnet 3 finally collides with the electromagnetic coil 2. The impact force can be made larger by longer accelerating time, and therefore the magnitude of the coil current J may be changed larger for the collision of the permanent magnet 3 with the electromagnetic coil 2 than for the departure of the permanent magnet 3 from the electromagnetic coil 2. In and after a time t4, an operation similar to the above is repeated, and the object-to-be-moved M is moved in inching to the left by the repetitive operation. When a position of the object-to-be-moved M is indicated by its left edge, the object-to-be-moved M is located at positions x0, x1, x2, and x3 in FIGS. 4A, 4B, 4C, and 4D, respectively. The movement of distance |x0-x1| is caused by a recoil generated when the permanent magnet 3 departs from the electromagnetic coil 2. The positions x1 and 2x are located at the same position. The movement of a distance |x2-x3| is caused by a recoil generated when the permanent magnet 3 collides with the electromagnetic coil 2.

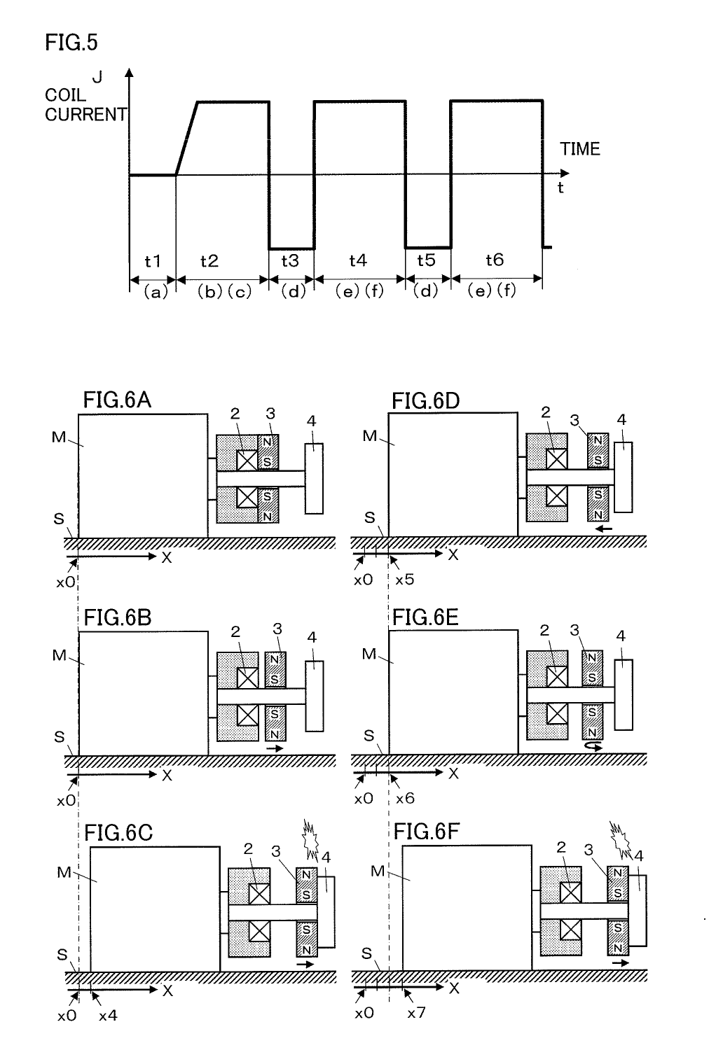

Next, an operation of the drive device 1 to move the object-to-be-moved M to the right is described with reference to FIGS. 5 to 6F. Symbols (a) to (f) in the graph of FIG. 5 approximately correspond to FIGS. 6A to 6F, respectively. The coil current J is zero in a time t1 in FIG. 5, and the object-to-be-moved M remains stationary as shown in FIG. 6A. When the coil current J gradually increasing at first and then becoming constant as in a time t2 is supplied, the permanent magnet 3 is subject to a repulsion force from the electromagnetic coil 2 and gets close to the stopper 4 as shown in FIGS. 6B and 6C, and during this time, its movement speed is continuously accelerated by the repulsion force, and the permanent magnet 3 finally collides with the stopper 4. The magnitude of the coil current J is gradually increased in the beginning of the time t2, and this is intended to depress the leftward movement of the object-to-be-moved M which would be caused by a recoil due to a rapid separation of the permanent magnet 3 from the electromagnetic coil 2. The coil current J of reversed polarity flows in a time t3, and as shown in FIG. 6D, the permanent magnet 3 is pulled back from the stopper 4. Before the permanent magnet 3 reaches the stopper 4, the coil current J of returned polarity, flows in a time t4, and the permanent magnet 3 collides with the stopper 4 as shown in FIGS. 6E and 6F. In and after a time t5, an operation similar to that in the times t3 and t4 is repeated, and the object-to-be-moved M is moved in inching to the right by the repetitive operation. Positions x4 to x7 are similar to the above positions x0 to x3, respectively.

A function of the friction surface S is described hereinafter. When the drive device 1 is located in free space, the gravity center of itself does not move in accordance with the motion of itself Moreover, when the drive device 1 is connected to the object-to-be-moved M, the drive device 1 relatively moves together with the object-to-be-moved M relative to a supporting object (the earth, for example) which supports the object-to-be-moved M. In this relative movement, the gravity center of all of the drive device 1, the object-to-be-moved M, and the supporting object does not move. However, irreversibility of the friction force on the friction surface S enables the gravity center of the system composed of the drive device 1 and the object-to-be-moved M to move relative to the supporting object. In order to exert the irreversibility, it is enough to fulfill the condition that when the object-to-be-moved M is moved to the left, for example, the impact force generated by the collision of the permanent magnet 3 with the electromagnetic coil 2 is larger than a static friction force on the friction surface S (the same shall apply to the case of moving the object-to-be-moved M to the right). The drive device 1 can move the object-to-be-moved M which meets the above condition to any of the right and left.

According to the first embodiment, the impact caused by the collision can be generated in any side of the direction of the relative movement of the electromagnetic coil 2 and the permanent magnet 3, and therefore a reciprocating movement of the object-to-be-moved M can be achieved. Moreover, since the drive device 1 is made by combining the permanent magnet 3 and the stopper 4 with one electromagnetic coil 2, a compact and simple configuration can be achieved. By using the above drive device 1, a movement mechanism such as a moving table, an inclination stage, or the like, for example, can be achieved by a compact, lightweight and simple configuration compared to a case of using a motor, a driving force transmission device, or the like.

### Modification Example of the First Embodiment

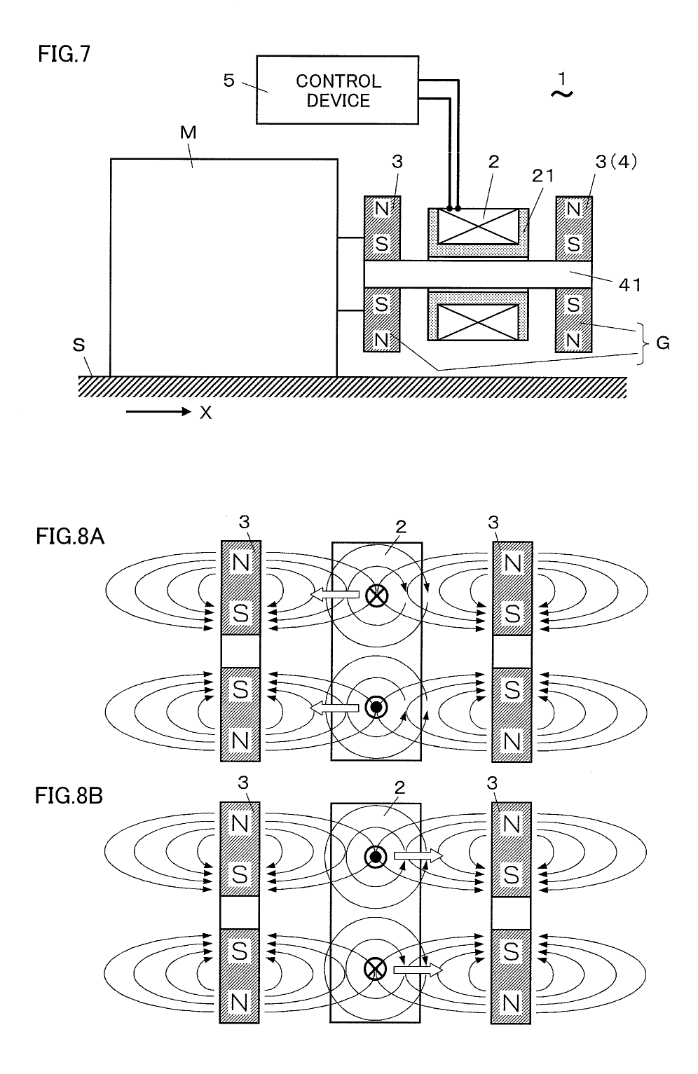

FIGS. 7 to 10C show a modification example of the drive device according to the first embodiment. As shown in FIG. 7, in the drive device 1 of the present modification example, the electromagnetic coil 2 and the permanent magnet 3 in the first embodiment are replaced with each other, and the stopper 4 in the first embodiment is replaced with another permanent magnet 3. That is to say, the drive device 1 includes the two permanent magnets 3 of a circular plate shape separately and coaxially fixed to both ends of the axial rod 41, the electromagnetic coil 2 movable along the axial rod 41, and the control device 5 which temporally controls the electrical current flowing in the electromagnetic coil 2. The electromagnetic coil 2 is placed in the coil frame 21 and inserted with the axial rod 41 through the central axis of the electromagnetic coil 2. The two permanent magnets 3 are integrated with each other by the axial rod 41 and form the collided-body G (in this case, the collided-body G indicates the object with which the electromagnetic coil 2 collides). The electromagnetic coil 2 relatively moves relative to the two permanent magnets 3 by the electromagnetic action caused by the electrical current-supply to the electromagnetic coil 2. The range of the relative movement of the electromagnetic coil 2 is restricted by the collided-body G (by the permanent magnets on the both ends). Each of the two permanent magnets 3 has a shape of the toroidal circular plate and is magnetized from the center side toward the outer periphery side in the radial direction. In the present modification example, the S pole is located on the center side and the N pole is located on the outer periphery side, however, the polarity may be reversed.

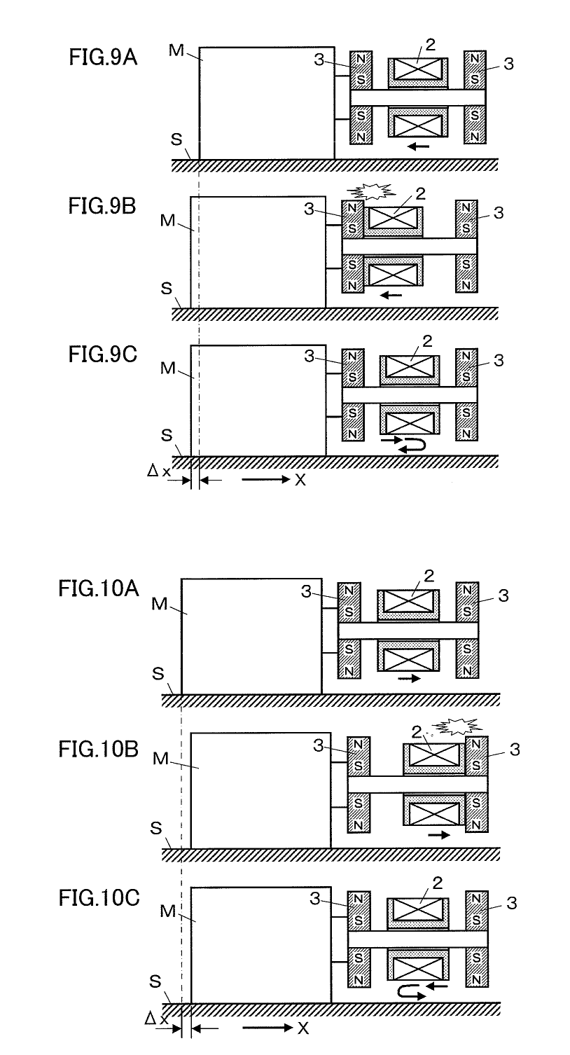

An operation of the drive device 1 is described. When the electrical current is supplied to the above electromagnetic coil 2 located between the permanent magnets 3, as shown in FIGS. 8A and 8B, the electromagnetic coil 2 is subject to the repulsion force from one permanent magnet 3 and is subject to the attraction force from the other permanent magnet 3. Accordingly, the movement direction of the electromagnetic coil 2, that is, the X axis direction and an opposite direction of the X axis direction, can be selected in accordance with the direction of the electrical current flowing in the electromagnetic coil 2. Thus, when the coil current of the electromagnetic coil 2 is temporally controlled by the control device 5, as shown in FIGS. 9A, 9B, and 9C, the electromagnetic coil 2 can be made to collide with the permanent magnet 3 located on the left side, and the object-to-be-moved M can be moved through a distance Ax to the left. Similarly, as shown in FIGS. 10A, 10B, and 10C, the electromagnetic coil 2 can be made to collide with the permanent magnet 3 located on the right side, and the object-to-be-moved M can be moved through the distance Ax to the right. The control device 5 (refer to FIG. 7) temporally controls the electrical current, generates the collision in one side of the direction of the relative movement of the electromagnetic coil 2 and the permanent magnet 3, and prevents the collision in the opposite side of the direction and reverses the relative movement, so that the control device 5 repeatedly generates the impact in one side of the direction. As described above, the control device 5 repeats the temporal control of the electrical current flowing in the electromagnetic coil 2, so that the object-to-be-moved M is moved in inching to the right or the left.

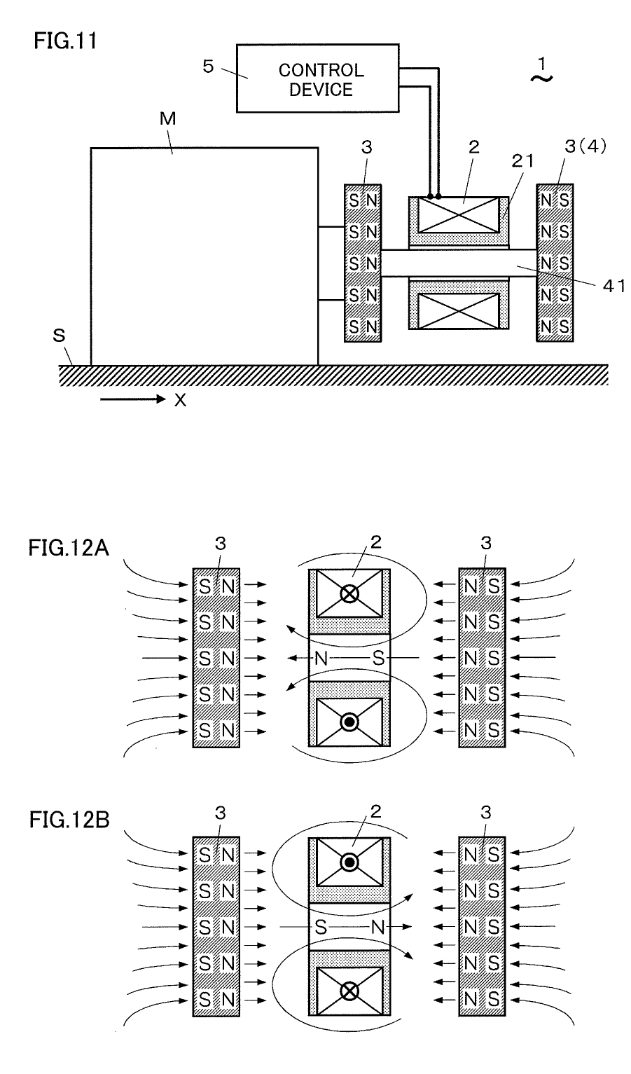

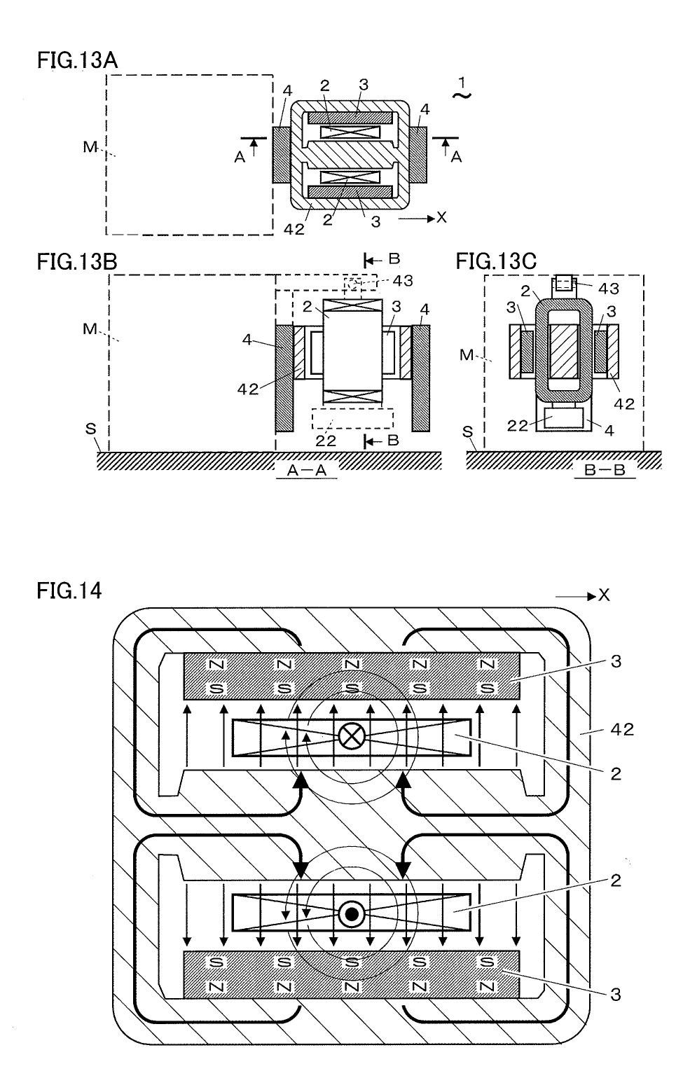

FIG. 11 shows a further modification example of the drive device 1 in FIG. 7. The permanent magnets 3 in the present modification example are magnetized in a thickness direction of the circular plate, unlike the magnetization direction of the permanent magnets 3 in the drive device 1 in FIG. 7. When the above permanent magnets 3 are placed so that their magnetization direction are the same with each other and the electrical current is supplied to the electromagnetic coil 2, as shown in FIGS. 12A and 12B, the electromagnetic coil 2 is subject to the repulsion force from one permanent magnet 3 and is subject to the attraction force from the other permanent magnet 3. Accordingly, the present modification example enables the operation similar to that of the drive device 1 in FIG. 7. The above modification examples enable the symmetrical configuration in both sides of the direction of the relative movement of the electromagnetic coil 2 and the permanent magnet 3, and therefore a symmetrical impact can be generated, and a drive control using the above configuration can easily be achieved.

### Another Modification Example of the First Embodiment

FIGS. 13A to 16B show another modification example of the drive device according to the first embodiment. As shown in FIGS. 13A, 13B, and 13C, the drive device 1 of the present modification example includes: two permanent magnets 3, each of which has a rectangular flat plate shape and is placed on an inner surface, wherein the two inner surfaces are of a rectangular magnetic circuit 42 and face each other; the electromagnetic coil 2 which is movably placed between the two permanent magnets 3; and the control device which is not shown in the drawings. The electromagnetic coil 2 and the two permanent magnets 3 are combined with each other to form a voice coil structure. A magnetic circuit is placed inside the magnetic circuit 42, which is inserted through the electromagnetic coil 2 (the insertion direction of the magnetic circuit is referred to the X axis direction), and the inserted magnetic circuit forms magnetic poles facing each of the permanent magnets 3. An upper portion of the electromagnetic coil 2 is rotatably supported by a rotation bearing 43. Moreover, a hammer 22 is provided on a lower portion of the electromagnetic coil 2 as a part of the electromagnetic coil 2. Stoppers 4 are provided on positions which the hammer 22 can collide with on both ends of an outer periphery of the magnetic circuit 42 in the X axis direction. The permanent magnets 3 and the stoppers 4 are integrated with each other to form the collided-body G (not shown).

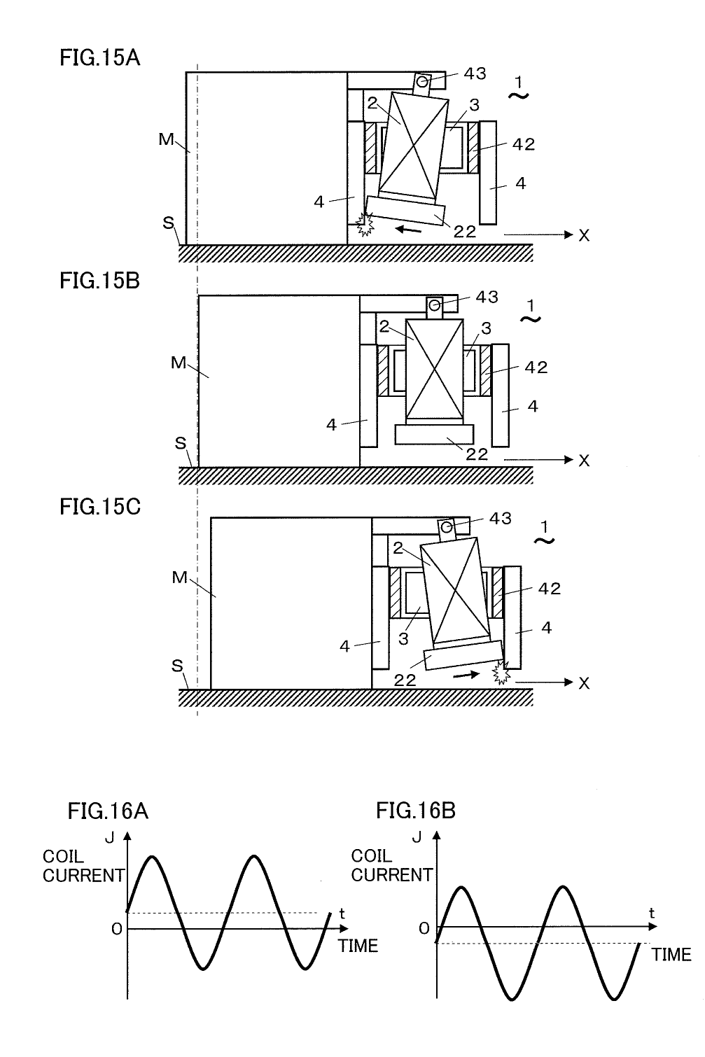

As shown in FIG. 14, an electromagnetic field of the permanent magnet 3 is set so that its direction is perpendicular to the X axis direction. Accordingly, when an electrical current is supplied to the electromagnetic coil 2 located in the electromagnetic field, the electromagnetic coil 2 is subject to a force to be moved in a forward direction of the X axis (the right direction in FIG. 14) or moved in a backward direction of the X axis (the left direction in FIG. 14) opposite to the forward direction in accordance with the direction of the coil current. Then, as shown in FIG. 15A, when the electromagnetic coil 2 is subject to the leftward force, the electromagnetic coil 2 pendularly swings to the left side and the hammer 22 collides with the stopper 4 on the left side, and the object-to-be-moved M is moved in the left direction. The control device (not shown) temporally controls the electrical current flowing in the electromagnetic coil 2 so that the electrical current changes with time, as shown in FIG. 16A, to make the drive device 1 repeat the above operation. The coil current J in this figure has a function form of a sine function changing with time and shifted to a positive direction of the coil current J. As shown in FIG. 15A, in the positive side of the coil current J, the electromagnetic coil 2 swings to the left side and collides there, and as shown in FIG. 15B, in the negative side of the coil current J, the electromagnetic coil 2 returns to a neutral point and subsequently repeats the movement to the left side and the collision there in accordance with the change of the coil current J with time. Moreover, when the object-to-be-moved M is moved to the right side, the coil current J changes with time as shown in FIG. 16B, and the electromagnetic coil 2 repeats the conditions shown in FIGS. 15A and 15B. The above modification example enables the symmetrical configuration in both sides of the direction of the relative movement of the electromagnetic coil and the permanent magnet, and therefore a symmetrical impact can be generated.

The above drive device 1 of the first embodiment and its modification examples can be described more generally as follows. That is to say, the drive device 1 is a device which moves an object-to-be-moved by providing an impact to the object-to-be-moved. The drive device 1 includes an electromagnetic coil 2, a permanent magnet 3 which relatively moves relative to the electromagnetic coil 2 by the electromagnetic action caused by electrical current supply to the electromagnetic coil 2, and the stopper 4 which restricts the range of the relative movement of the permanent magnet 3. The stopper 4 is integrated with the electromagnetic coil 2 or the permanent magnet 3 to form a collided-body G and restricts the range of the relative movement. When the electrical current is supplied to the electromagnetic coil 2, the collided-body G collides with the electromagnetic coil 2 or the permanent magnet 3 not integrated in the collided-body G, and this collision generates the impact. Regarding the above expression, the collided-body G is made up of the permanent magnet 3 and the stopper 4 in the first embodiment. One more permanent magnet 3 is included, and the collided-body G is made up of the two permanent magnets 3, one of which replaces the stopper 4, in the modification example in FIGS. 7 to 12B. Moreover, the collided-body G is made up of the permanent magnet 3 and two stoppers 4 in the modification example in FIGS. 13A to 16B. The effect of the drive device 1 in a generalized expression as above is described as below. Since the impact caused by the collision can be generated in any side of the direction of the relative movement of the electromagnetic coil 2 and the permanent magnet 3, the reciprocating movement of the object-to-be-moved M can be achieved. Moreover, since the drive device 1 is made by combining the permanent magnet 3 and the stopper 4 with one electromagnetic coil 2, the configuration can be made compact and simple. By using the above drive device 1, the movement mechanism such as a moving table, an inclination stage, or the like, for example, can be achieved by a compact, lightweight and simple configuration compared to a case of using a motor, a driving force transmission device, or the like.

### Second Embodiment

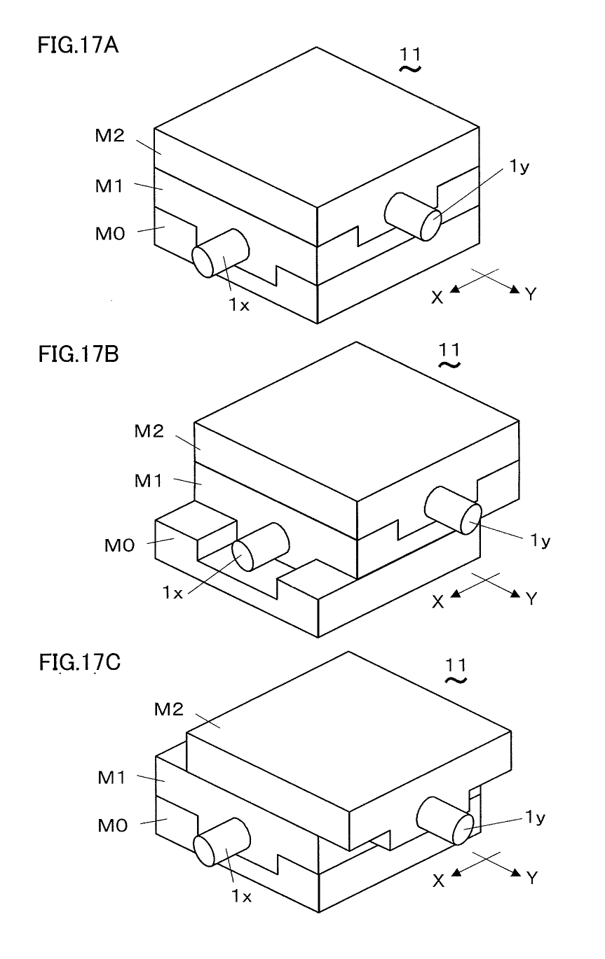

FIGS. 17A to 17C show a movement mechanism according to the second embodiment. As shown in FIG. 17A, a movement mechanism 11 of the present embodiment includes a base table M0, a first moving table M1, a second moving table M2, and drive means 1x and 1y. The first moving table M1 is supported by the base table M0 and is movable along the X axis direction. The second moving table M2 is supported by the moving table M1 and is movable along the Y axis direction perpendicular to the X axis direction. The drive means 1x and 1y drive and move the first and second moving tables M1 and M2, respectively. In the movement mechanism 11, the drive device 1 according to any of the above first embodiment 1 and the modification examples of the first embodiment 1 is used as the drive means 1x and 1y. The movement mechanism 11 is made by putting one linear motion guide on top of another linear motion guide in X and Y directions, respectively, and makes up an XY table.

The support of the first moving table M1 by the base table M0 and the support of the second moving table M2 by the first moving table M1 are made via friction surfaces (corresponding to the friction surface S in FIG. 1). Accordingly, as shown in FIG. 17B, the whole of the first moving table M1 and the second moving table M2 on the top of the first one is driven along the X axis direction in accordance with the operation of the drive means 1x. Moreover, as shown in FIG. 17C, the second moving table M2 is driven along the Y axis direction in accordance with the operation of the drive means 1y. When the first and second moving tables M1 and M2 are put on each other so that they are driven in the same direction, a movement mechanism of a rectilinearly movable table is achieved. Moreover, a movement mechanism of a rectilinearly movable table can also be achieved by putting only the first moving table M1 without putting the second moving table M2 on the first moving table M1. According to the second embodiment, the XY table or the rectilinearly moving table can be achieved by the compact and simple configuration without using a motor, a driving force transmission device, or the like.

### Modification Example of the Second Embodiment

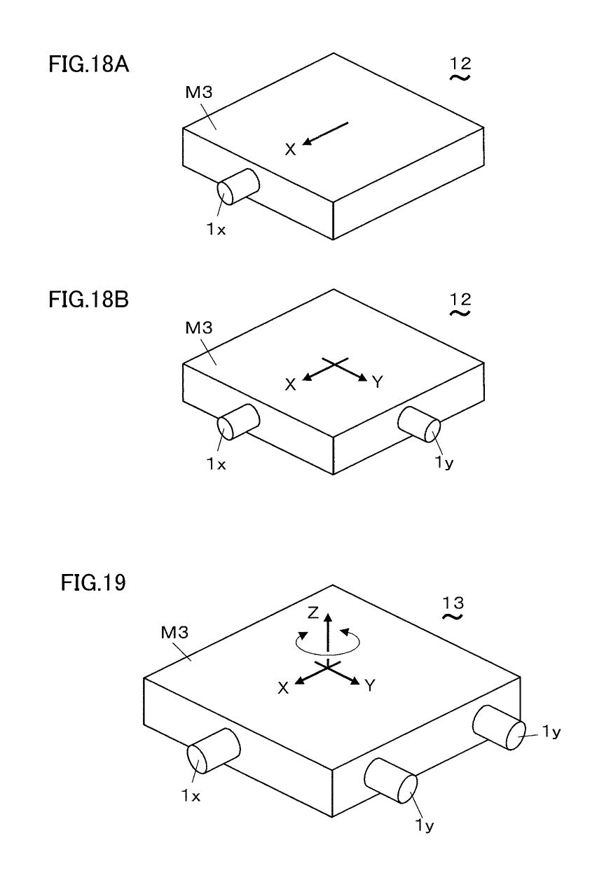

FIGS. 18A to 19 show a modification example of the movement mechanism according to the second embodiment. A movement mechanism 12 in FIG. 18A includes a moving table M3 of a flat plate shape used placing on a flat friction surface and a drive means 1x which generates a driving force along an X axis direction parallel to the friction surface. In the movement mechanism 12, the drive device 1 according to any of the above first embodiment 1 and the modification examples of the first embodiment 1 is used as the drive means 1x. Moreover, the movement mechanism 12 in FIG. 18B further includes a drive means 1y which generates a driving force in a Y axis direction parallel to the friction surface and perpendicular to the X axis direction, in addition to the movement mechanism 12 in FIG. 18A. In the same manner as the drive means 1x, the drive device 1 according to any of the above first embodiment 1 and the modification examples of the first embodiment 1 is used as the drive means 1y. The above movement mechanism 12 enables a rectilinear movement or a two-dimensional movement of the moving table M3 on the flat surface by a simple configuration. A movement mechanism 13 in FIG. 19 includes a moving table M3 of a flat plate shape used placing on a friction surface, and drive means 1x and 1y which respectively provide driving forces to the moving table M3 along an X axis direction and a Y axis direction which are parallel to the moving table M3 and perpendicular to each other. In the same manner as the above configuration, the drive device 1 according to any of the above first embodiment 1 and the modification examples of the first embodiment 1 is used as the drive means 1x and 1y. The drive means 1x generates the driving force acting on a gravity center of the moving table M3 along the X axis direction and thus enables a reciprocating movement of the moving table M3 along the X axis direction. There are two for the drive means 1y, and lines of action of their driving forces deviate from the gravity center of the moving table M3. Accordingly, when the directions of the driving forces generated the two drive means 1y are opposite to each other in the Y axis direction, the moving table M3 rotates around a Z axis direction perpendicular to the X and Y axes.

Moreover, when the directions of the driving forces generated the two drive means 1y are the same with each other and moments of force acting on the moving table M3 are in balance with each other, the moving table M3 is moved along the Y axis direction. Accordingly, when the three drive means 1x, 1y, and 1y are driven, the moving table M3 can be moved in three degrees of freedom, that is to say, the two-dimensional parallel movement in the XY surface and the rotation movement around the Z axis. Moreover, when the two drive means 1x are provided in parallel with each other in the movement mechanism 12 in FIG. 18A, the two-dimensional movement of the moving table M3 can be achieved by controlling the drive means 1x in a similar manner to a steering of a hand cart by pushing and pulling with both hands of a human. Moreover, when the two drive means 1x are provided on right and left sides of the moving table M3 in the X axis direction, the two drive means 1x can be looked upon as drive wheels on right and left sides of a vehicle, and the two-dimensional movement of the moving table M3 can be achieved by controlling them. Moreover, when a sensor, a control device, and so on for a steering or an autonomous movement are mounted on such a movement mechanism, an autonomous moving device can be achieved. According to the above modification examples, an X table, an XY table, an XYθ table, or the like can easily be achieved with a compact and simple configuration without using a motor, a driving force transmission device, or the like.

### Third Embodiment

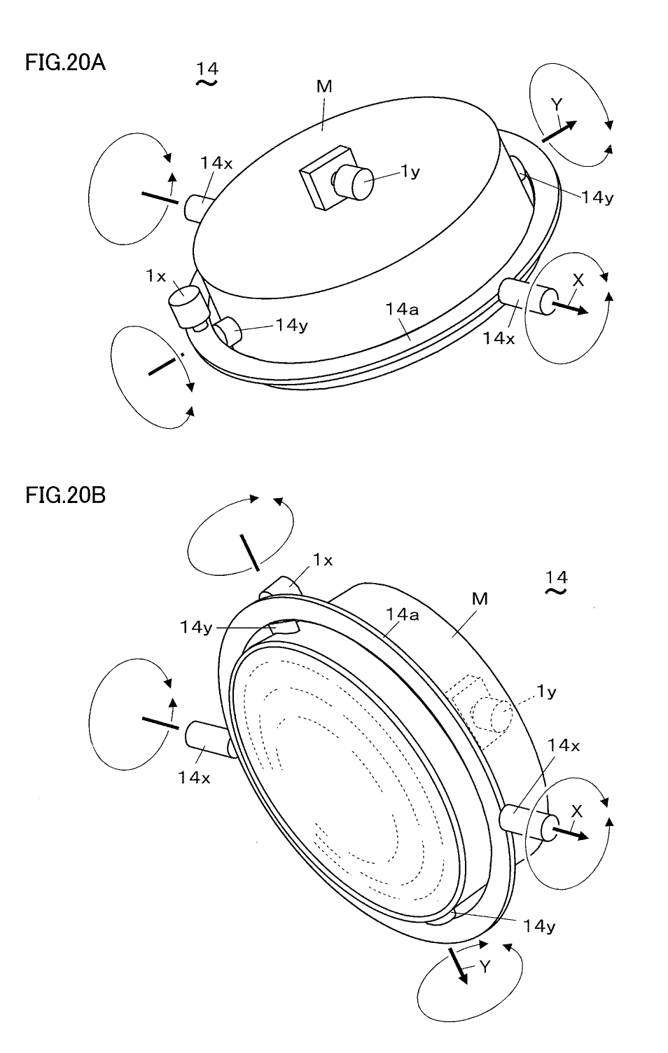

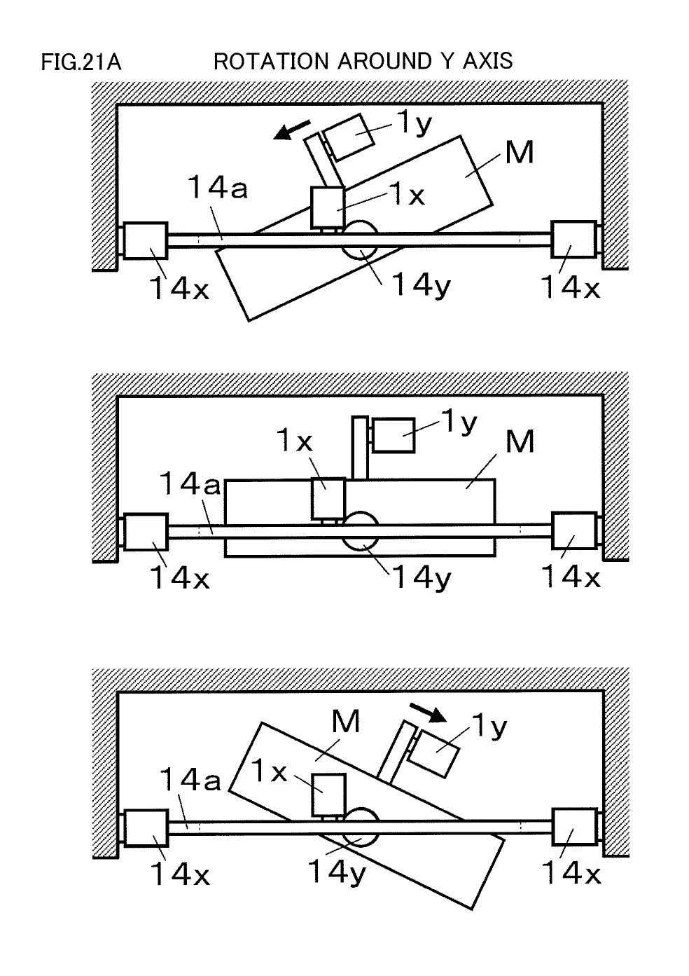

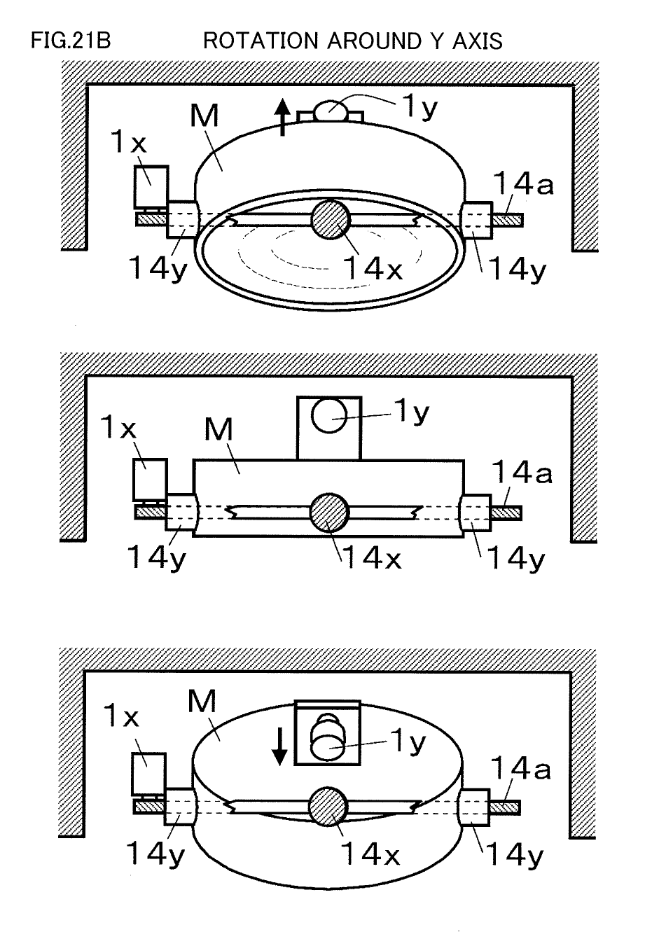

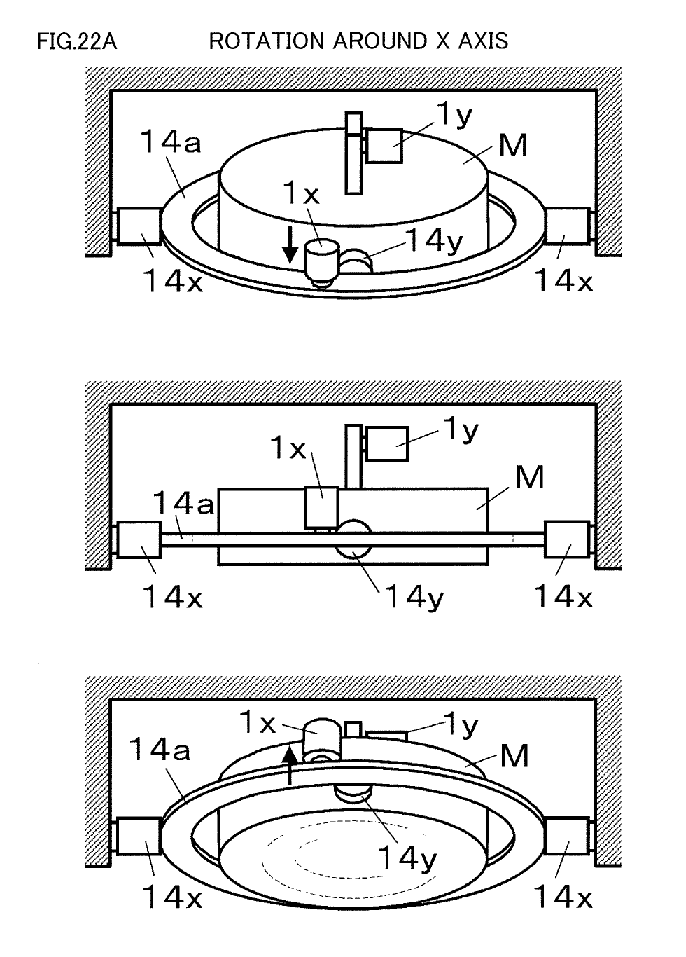

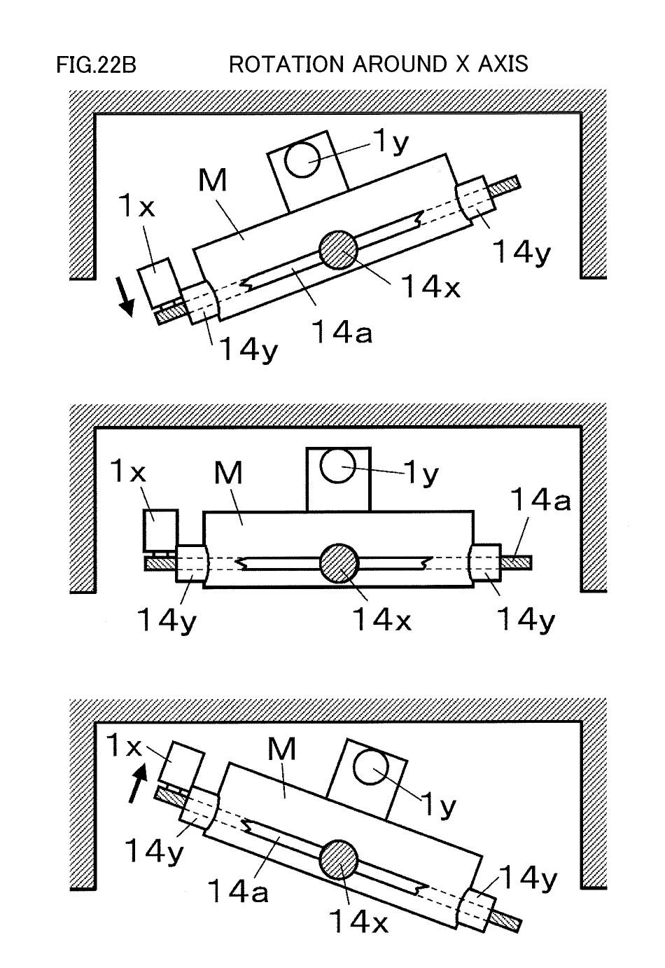

FIGS. 20A, 20B, 21A, 21B, 22A and 22B show a movement mechanism according to the third embodiment. A movement mechanism 14 of the present embodiment rotationally moves an object-to-be-moved M by a gimbal structure and changes a posture of the object-to-be-moved M. As shown in FIGS. 20A and 20B, the movement mechanism 14 includes a circular ring 14a, rotation bearings 14x, rotation bearings 14y, a rotary drive means 1x, and a rotary drive means 1y. The rotation bearings 14x support the circular ring 14a from a stationary side so that the circular ring 14a can rotate around an X axis. The rotation bearings 14y support the object-to-be-moved M so that the object-to-be-moved M can rotate with respect to the circular ring 14a around a Y axis perpendicular to the X axis. The rotary drive means 1x generates a moment of force around the X axis for the circular ring 14a. The rotary drive means 1y generates a moment of force around the Y axis for the object-to-be-moved M. The gimbal structure is configured being provided with the circular ring 14a and the rotation bearings 14x and 14y. The drive device 1 according to any of the above first embodiment 1 and the modification examples of the first embodiment 1 is used as the rotary drive means 1x and 1y. Each of the rotation bearings 14x and 14y is adjusted to generate an appropriate friction force so that the function of the drive device 1 is exerted. Moreover, a ratchet mechanism or the like may also be provided to enable the rotation in each of the rotation bearings 14x and 14y in only one direction without using the friction force. In this case, the rotation can be reversed by reversing a working direction of the ratchet. By setting positions, in which greater moments of force can be generated (positions in which moment arms are longer respectively), as positions of the rotary drive means 1x and 1y, the drive device 1 with a smaller impact force can be used. When the object-to-be-moved M is an illuminating device and is mounted on a wall of a building or a concave portion of a ceiling as shown in FIGS. 21A, 21B, 22A, and 22B, the wall or the concave wall of the ceiling is used as a stationary side, and the object-to-be-moved M (the illuminating device) is mounted by the rotation bearings 14x. FIGS. 21A and 21B show rotary driving around the Y axis, and FIGS. 22A and 22B show rotary driving around the X axis. The inclination control for pan and tilt of the illuminating device can be achieved by operating the rotary drive means 1x and 1y. According to the third embodiment, the movement mechanism which can control the inclination angle, the rotation angle, or the like of the moving object supported by the gimbal structure can be achieved with a compact and simple configuration without using a motor, a driving force transmission device, or the like.

### Still Another Modification Example of the First embodiment

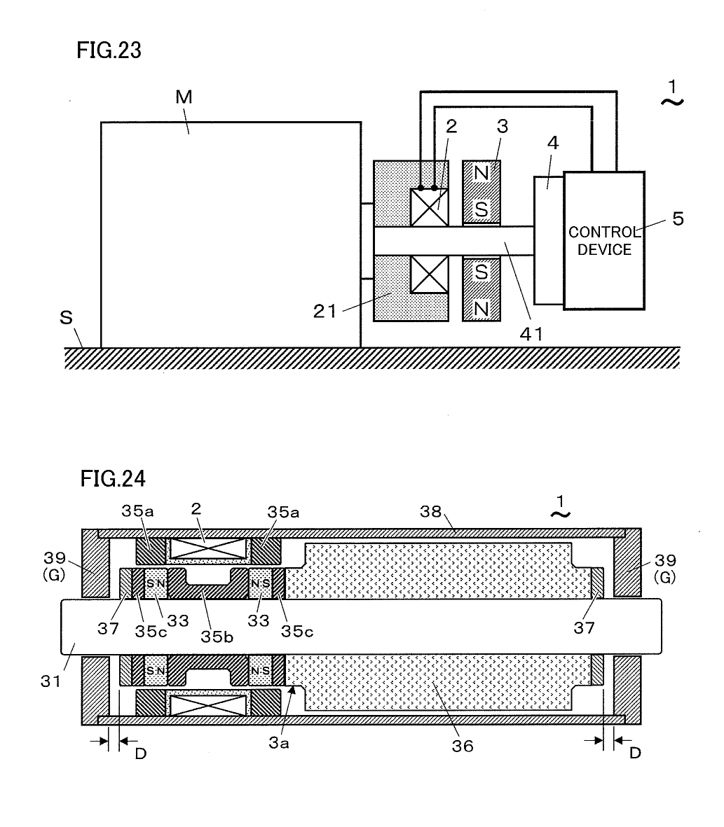

FIG. 23 shows the still another modification example of the drive device according to the first embodiment. The drive device 1 of the present modification example is the one that the control device 5 to control the electrical current supplied to the electromagnetic coil 2 is integrated with a main body of the drive device 1 in the above first embodiment 1. Since the drive device 1 is provided with the control device 5, an easy-to-use drive device and an easy-to-use movement mechanism can be achieved. The control device 5 includes a circuit which temporally controls the electrical current supplied to the electromagnetic coil 2, for example. The control device 5 may also have an electric power source. Moreover, when the control device 5 is provided with a wire communication means or a wireless communication means using infrared light, radio waves, or the like, the drive device 1 and the movement mechanism using the drive device 1 can be remotely controlled. Moreover, in the same manner as the present modification example, a control device which controls the electrical current supplied to the electromagnetic coil 2 may be integrated with a main body of the drive device 1 in the above FIGS. 7 to 16B and further the following FIGS. 24, 25A, 25B, 26A, 26B, 26C, and 26D.

### Still Another Modification Example of the First Embodiment

FIGS. 24, 25A, 25B, 26A, 26B, 26C, and 26D show a still another modification example of the drive device according to the first embodiment. The drive device of the present modification example may be applied as the drive device for the above movement mechanism in the same manner as the other drive device. As shown in FIG. 24, the drive device 1 of the present modification example is provided with a electromagnetic coil 2, stators 35a located on the both ends of the electromagnetic coil 2, and a moving mass body 3a which is integrated with an axial rod 31 reciprocating along the central axis of the electromagnetic coil 2 and the stators 35a. The moving mass body 3a relatively moves relative to the electromagnetic coil 2 and the stators 35a. The moving mass body 3a includes the axial rod 31, two permanent magnets 33 each of which is placed within the inner diameter side of each of the stators 35a, an iron core 35b which is inserted between the two permanent magnets 33, yokes 35c which are located at both outsides of the two permanent magnets 33, two collision heads 37, and an impact reinforce weight 36. One of the collision heads 37 is located in contact with one of the yokes 35c, and the other collision head 37 is located on the other yoke 35c with the collision head 37 (sic) therebetween. Moreover, the drive device 1 further includes an external cylinder (a shield case 38) housing the electromagnetic coil 2, the stators 35a, and the moving mass body 3a and bearing plates 39 (the collided-bodies G) located at both ends of the shield case 38 to support the axial rod 31. The electromagnetic coil 2 and the stators 35a are fixed to the inner wall of the shield case 38. FIG. 24 shows a state in which no electrical current is supplied to the electromagnetic coil 2. In this state, the moving mass body 3a is positioned at a neutral point by an attraction force caused by a magnetic field of the permanent magnets 33, the iron core 35b, the yokes 35c, and the stators 35a.

The axial rod 31 is coaxial with the electromagnetic coil 2 and the stators 35a. The constituents of the moving mass body 3a are located coaxially with the axial rod 31 and are integrated with the axial rod 31. A length of the iron core 35b is equivalent to that of the electromagnetic coil 2. In other words, the iron core 35b has a length so that the iron core 35b is fitted between the stators 35a. Moreover, the iron core 35b has a shape with flanges on both ends of the cylinder, so that a radius in its center is smaller than that in the both ends. Accordingly, a magnetic circuit is formed, which has a reduced magnetic resistance between the both ends of the iron core 35b and the adjacent stators 35a. Each of the stators 35a is of magnetic material. The permanent magnets 33 have a shape of a ring and are magnetized in its thickness direction (central axis direction). Moreover, the two permanent magnets 33 are located on both ends of the iron core 35b with their magnetization directions opposite to each other. The thickness of one permanent magnet 33 is smaller than that of one stator 35a, and a total amount of the thickness of one permanent magnet 33 and one yoke 35c is larger than that of one stator 35a.

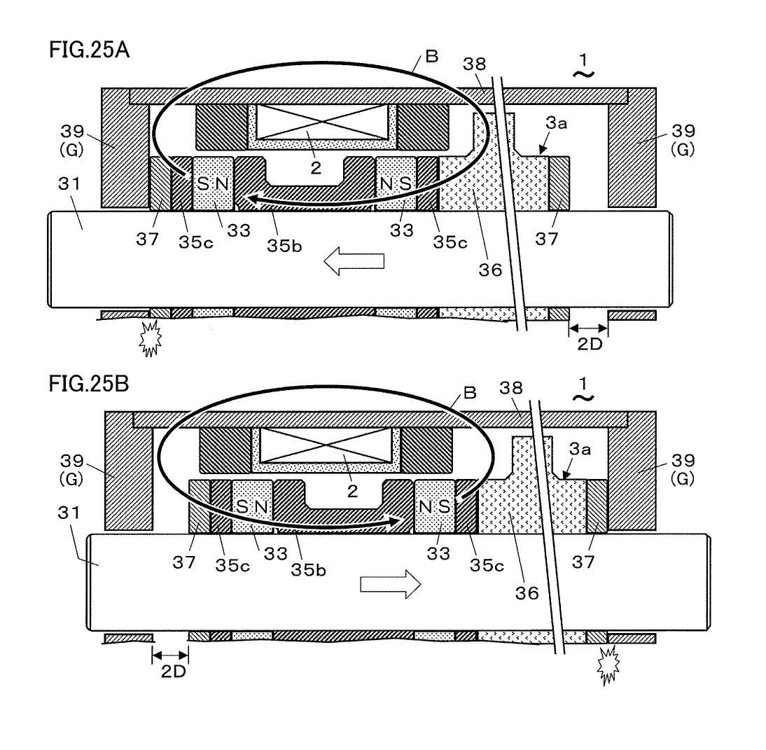

In the neutral state shown in FIG. 24, distances D between the two collision heads 37 and the bearing plates 39 which face the collision heads 37, respectively, are equal to each other. The bearing plate 39 is the collided-body G, to which the collision head 37 collides, and restricts a range of relative movement of the moving mass body 3a, which is integrated with the axial rod 31, relative to the electromagnetic coil 2 and the stator 35a. That is to say, the range in which the moving mass body 3a can move is twice the distance D (refer to FIGS. 25A and 25B). The distance D is set within such a distance that the moving mass body 3a can return from a position where the moving mass body 3a collides with either of the collision heads 37, to the neutral point by a mutual attraction force of the permanent magnets 33 and the stators 35a.

A principle of operation in the drive device 1 is described with reference to FIGS. 25A and 25B. When an electrical current is supplied to the electromagnetic coil 2 in a constant direction, a magnetic field is generated as schematically indicated by a magnetic line B in FIG. 25A. The magnetic field of the electromagnetic coil 2 decreases the magnetic field of one permanent magnet 33 and increases the magnetic field of the other permanent magnet 33. Accordingly, the magnetic field generated by the electromagnetic coil 2 causes asymmetricity in the magnetic force exerted on the permanent magnets 33, the iron core 35b, and the yokes 35c, and thus the moving mass body 3a moves in a direction indicated by a hollow arrow. When the electrical current is supplied to the electromagnetic coil 2 in an opposite direction of the above constant direction, as shown in FIG. 25B, the moving mass body 3a moves in an opposite direction of the above direction shown in FIG. 25A. Moreover, when the coil current is turned off and the magnetic field from the electromagnetic coil 2 is eliminated in FIGS. 25A and 25B, the moving mass body 3a returns to the neutral point by the mutual attraction force of the permanent magnets 33 and the stators 35a as shown in FIG. 24. In this case, the electrical current may appropriately be supplied to the electromagnetic coil 2 to accelerate the return of the moving mass body 3a.

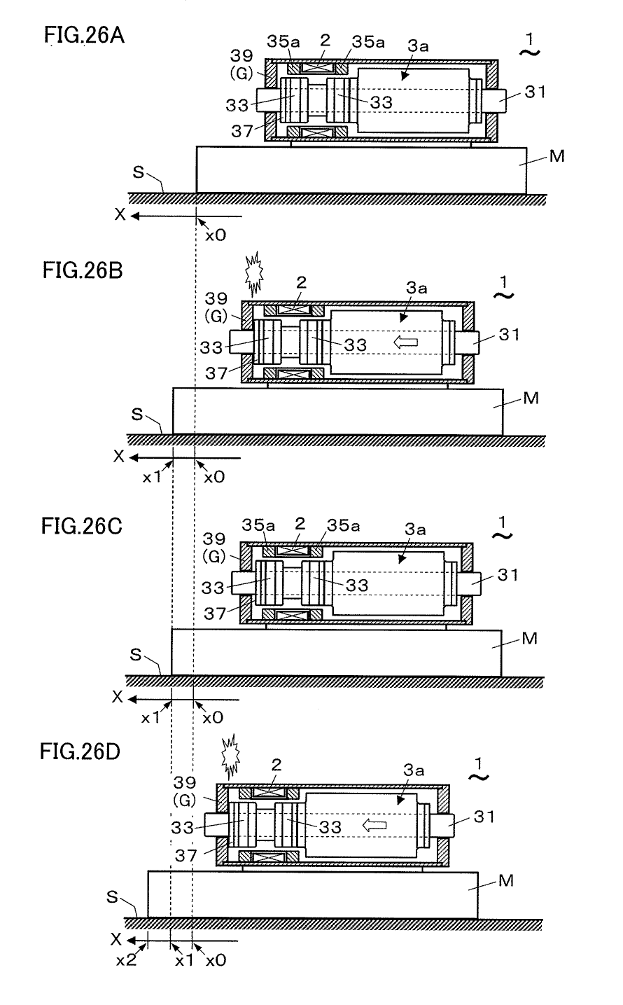

An operation of the drive device 1 is described with reference to FIGS. 26A to 26D. As shown in FIG. 26A, the drive device 1 is mounted on the object-to-be-moved M which is located on the horizontal friction surface S, for example. In particular, for example, the shield case 38 is fixed to the object-to-be-moved M. A direction of movement is defined as left in the figure and X direction, and the axis direction of the axial rod 31 is set as X direction. In the state of this figure, the electromagnetic coil 2 is not excited, the moving mass body 3a is positioned at the neutral point, and the left edge of the object-to-be-moved M is located in the position x0. When the electrical current is supplied to the electromagnetic coil 2, as shown in FIG. 26B, the moving mass body 3a moves and collides with the bearing plate 39, and an impact caused by the collision makes the object-to-be-moved M move together with the drive device 1, and the edge of the object-to-be-moved M reaches the position x1. A magnitude of the impact depends on a magnitude and a rate of rise of the electrical current supplied to the electromagnetic coil 2, and therefore as the larger electrical current is supplied more rapidly, the larger impact can be generated. When the electrical current supplied to the electromagnetic coil 2 is turned off after the collision, the moving mass body 3a in the drive device 1 returns to the neutral point as shown in FIG. 26C. Since this return movement is slowly performed by the magnetic force of the permanent magnets 33, no recoil which exceeds the static friction force between the object-to-be-moved M and the friction surface S occurs, and thus the object-to-be-moved M does not move. In other words, the condition setting such as adjusting the magnetic force of the permanent magnet 33, adjusting the friction force from the friction surface S, and so on are performed, so that the object-to-be-moved M does not move when the moving mass body 3a returns to the neutral point. In the same manner as the above configuration, when the electrical current is supplied to the electromagnetic coil 2 again, as shown in FIG. 26D, the edge of the object-to-be-moved M further moves and reaches the position x2. The drive device 1 can make the object-to-be-moved M located to be pushed or pulled move intermittently by repeating the above operation.

The present invention is not limited to the above configurations and can be modified variously. For example, each of the above embodiments and modification examples may be combined with each other. Moreover, in the above configurations, the object-to-be-moved M is described to be supported by the friction surface S, however, the present invention is not limited to such configurations. The drive device 1 may be applied to any object-to-be-moved M, which is under a condition to make the drive device 1 exert its function enough, for example, the one supported under a resistance similar to the friction force, in addition to the one supported by the ratchet mechanism or the like. For example, the drive device 1 may be applied to any object-to-be-moved M which is under a resistance from a liquid, a gas, a granulated substance such as sand or grain, a powder substance, or the like. Moreover, the permanent magnet 3 of the first embodiment or the electromagnetic coil 2 of the modification example in FIG. 7, and so on, which relatively move relative to the collided-body G and collide with it, and the collided-body G are the components mutually having the relative functions. Accordingly, it is also applicable that in the drive device 1 shown in FIGS. 1 to 16B and 23 to 25B, the permanent magnet 3 and the electromagnetic coil 2 which move relative to the collided-body G are fixed to the object-to-be-moved M and the collided-body G collides with these permanent magnet 3 and the electromagnetic coil 2. Furthermore, in the modification example shown in FIGS. 13A to 16B, the electromagnetic coil 2 is described to swing pendularly, however, it is also possible to make a configuration moving parallel to the X axis direction.

The present invention is based on Japanese Patent Application No. 2010-31840, and as a result, the subject matter is to be combined with the present invention with reference to the specification and drawings of the above patent application.

### DESCRIPTION OF THE NUMERALS

1, 1x, 1y drive device
2 electromagnetic coil
3, 33 permanent magnet
4 stopper
5 control device
11, 12, 13, 14 movement mechanism
M object-to-be-moved
M1, M2, M3 moving table

1. A drive device for providing an impact to an object-to-be-moved and moving the object-to-be-moved, comprising:
an electromagnetic coil;
a permanent magnet which relatively moves relative to the electromagnetic coil by an electromagnetic action caused by an electrical current-supply to the electromagnetic coil; and
a stopper for restricting a range of relative movement of the electromagnetic coil or the permanent magnet, wherein the stopper forms a collided-body by being integrated with either the electromagnetic coil or the permanent magnet, and
when an electrical current is supplied to the electromagnetic coil, the collided-body collides with either the electromagnetic coil or the permanent magnet which is not integrated in the collided-body, and generates the impact to the object-to-be-moved.

2. The drive device according to claim 1, wherein the stopper has a non-magnetic material and forms the collided-body by being integrated with the non-magnetic material and the electromagnetic coil,
the permanent magnet is placed between the stopper and the electromagnetic coil and can relatively move therebetween relative to the electromagnetic coil, and
the permanent magnet collides with the electromagnetic coil by an attraction force caused by the electromagnetic action or collides with the stopper by a repulsion force caused by the electromagnetic action, and generates the impact.

3. The drive device according to claim 1, wherein the stopper has another permanent magnet which differs from the permanent magnet, and forms the collided-body by being integrated with those two permanent magnets,
the electromagnetic coil is placed between the two permanent magnets and can relatively move therebetween relative to the respective permanent magnets, and
the electromagnetic coil collides with one of the two permanent magnets by an attraction force and a repulsion force received from the two permanent magnets by the electromagnetic action, and generates the impact.

4. The drive device according to claim 1, wherein
the electromagnetic coil and the permanent magnet are combined with each other to make a voice coil structure,
the stopper has a non-magnetic material and forms the collided-body by being integrated with the non-magnetic material and the permanent magnet on both ends of the permanent magnet in a direction of the relative movement,
the electromagnetic coil can relatively move between the stopper relative to the permanent magnet, and
the electromagnetic coil collides with the stopper by a force which is caused by the electromagnetic action received from the permanent magnet, and generates the impact.

5. The drive device according to claim 1, comprising
a control device which temporally controls an electrical current flowing to the electromagnetic coil,
the control device supplies a current to generate the collision in one direction of the relative movement, and supplies a current reversely to prevent the collision in an opposite of one direction, so that the impact is repeatedly generated in one direction.

6. A movement mechanism, comprising:
a first moving table;
a second moving table which is supported by the first moving table and relatively moves relative to the first moving table; and
drive means which drive and move the first and second moving tables, respectively, wherein
the drive device described in claim 1 is used as the drive means.

7. A movement mechanism, comprising:
a moving table which moves on a flat surface; and
drive means which drives and moves the moving table, wherein
the drive device described in claim 1 is used as the drive means.

8. A movement mechanism, comprising:
a gimbal structure; and
a rotary drive means which rotationally moves a rotatable structure around rotational axis in the gimbal structure, wherein
the drive device described in claim 1 is used as the rotary drive means.
